(19) United States
(12) Patent Application Publication
(10) Pub. No.: US 2003/0185997 A1
(43) Pub. Date: Oct. 2, 2003

(54) Method of reducing the chamber particle level

(76) Inventor: Yen-Wu Hsieh, Tao-Yuan (TW)

Correspondence Address: POWELL, GOLDSTEIN, FRAZER & MURPHY LLP, P.O. BOX 97223, WASHINGTON, DC, 20090-7223, US

(21) Appl. No.: 10/105,339

(22) Filed: Mar. 26, 2002

(51) Int. Cl. B05D 1/36; B05D 7/00

(52) U.S. Cl. 427/569; 427/402

(57) ABSTRACT

A method of reducing the chamber particle level. Firstly, clean a chamber and form a passivation layer on an inner surface of the chamber. Then, perform some fabrication process inside the chamber, wherein the interaction between the fabrication processes and the chamber is negligible. In short, the key-point is forming a passivation layer, which essentially does not interact with the fabrication processes, on the inner surface before the fabrication processes are performed. The passivation layer could decrease any defect, such as particle level and peeling, induced by the previous interaction. For example, before a chlorine plasma is used to etch, a passivation layer, which essentially does not interact with the chlorine plasma, could be formed on the inner surface of the etch chamber by the usage of a fluorine-chlorine plasma.

### BACKGROUND OF THE INVENTION

1. Field of the Invention

The invention relates to the method of reducing the chamber particle level, and also is related to the method of enhancing the efficiency of a plasma chamber.

2. Description of the Prior Art

For the conventional semiconductor fabrication, especially for the semiconductor factory that requires extremely high yield, it is desired to ensure that each wafer is processed under a clean environment and all wafers are processed under the same environment. Thus, it is normal that a clean process and a season process are performed while the chamber operating time exceeding a predetermined period or the pollution inside the chamber exceeding a predetermined level, and then use the chamber to process the wafer(s) again. Herein, season process is used to let the environment inside the chamber is stable and the clean process is used to remove population inside the chamber.

However, because the wafer(s) is processed inside the chamber, any fabrication process which acts on the wafer(s) would inevitably also interacts with the inner surface of the chamber, such as the sidewall and the bottom of the chamber, and part(s) inside the chamber, such as the wafer holder. Although the degree of the previous interaction is different to the degree of interaction between the fabrication process and the wafer(s). For example, the deposition process not only deposit a layer on the wafer but also deposition the material of the layer on the inner surface, and the etch process not only etch the wafer but also damage the inner surface.

Significantly, whenever some fabrication processes are performed inside the chamber, the effect one formed fabrication process affects on the inner surface would affect the sequential fabrication process(es) by through the interaction between the inner surface and the later fabrication process. For example, the material that one deposition process deposits on the inner surface probably would be etched by one sequential etch process, and then some particles are formed and probably pollute the etched water. For example, whenever two sequential fabrication processes use two different plasmas, the former fabrication process would form a polymer layer on the inner surface of the chamber. Thus, the interaction between the later fabrication process and the polymer layer would pollute the plasma used by the later fabrication process, which inevitably reduces the efficiency and the yield of the later fabrication process.

Furthermore, even only one fabrication process is performed between two clean process, owing to the truth that the fabrication process probably interact with the inner surface of the chamber, or the fabrication process probably interact with the polymer which the fabrication process itself formed on the inner surface,, inevitably, the wafer still would be polluted by the particles of the peeling polymer from the inner surface.

Accordingly, the conventional semiconductor fabrication could not effectively eliminate the pollution which induced by the interaction between the fabrication process(es) and the inner surface of the chamber. Thus, the chamber particle level and the pollution inside the chamber are large, and then not only the mean time between clean (MTBC) of the chamber is limited but also the efficiency of the chamber is decreased. In other words, this still is an open and unsolved problem.

### SUMMARY OF THE INVENTION

One main object of this invention is to provide a method of reducing the chamber particle level.

Another main object of this invnetion is to provide a method of enhancing the efficiency of a plasma chamber.

Still one object of this invention is to achieve two previous objects without obviously amend the conventional technology and the conventional device.

One preferred embodiment of this invention is a method of reducing the chamber particle level. First, clean the chamber. Then, form a passivation layer on an inner surface of the chamber. Then perform at least one fabrication process inside the chamber, where the fabrication processes do not react with the passivation layerfabrication process. Clearly, the material and the formation of the passivation layer are dependent on the contents of these fabrication processes.

Another preferred embodiment of this invention is a method of enhancing the efficiency of a plasma chamber. First, clean the plasma chamber. Then, perform a season process with a first plasma to form a passivation layer on an inner surface of the plasma chamber. And, perform at least one fabrication process inside the chamber withfabrication process a second plasma to treat a wafer inside the chamber fabrication process. For example, while the second plasma comprising chlorine and does not include fluorine, the first plasma at least comprises both chlorine and fluorine.

### BRIEF DESCRIPTION OF THE DRAWINGS

A more complete appreciation and many of the attendant advantages will be readily obtained as the same becomes better understood by reference to the following detailed description when considered in connection with the accompanying drawings.

FIG. 1 is an essential flowchart of one preferred embodiment;

FIG. 2 is an essential flowchart of one preferred embodiment; and

FIG. 3 is table for showing the brief comparison between an applied example of the invention and the conventional technology.

### DESCRIPTION OF THE PREFERRED EMBODIMENT

Aims at the defects of the conventional technology, the invention firstly emphasizes the basic method of eliminating the pollution is to amend both the configuration of the chamber and the parameters of these fabrication process to let all fabrication processes be separated from the inner surface of the chamber, and then not interaction would induce any pollution.

However, the cost and difficulty of the previous method is too high to be acceptable. Hence, the claimed invention solves the defects by another way: although fabrication processes almost contact with the inner surface, the pollution is appeared only while the interaction between the inner surface and the fabrication processes producing movable particles inside the chamber, where the producing particles would move to the wafer or induce some damages in and on the inner surface. In other words, while the interaction being properly prevented or even fully eliminated, the pollution could be effectively decreased or even fully eliminates, and it is possible to reduce the chamber particle level and to enhance the efficiency of the chamber.

Furthermore, the invention emphasizes the following truth: while the inner surface of the chamber being covered by a passivation before some fabrication processes are performed inside the chamber, where the material of the passivation layer is chosen to let the passivation layer do not interact with the fabrication processes, essentially no particle or damage would be induced by the interaction between the passivation layer and the fabrication processes. Thus, the chamber particle level inside the chamber is significantly decreased and then the mean time between clean (MTBC) of the chamber is prolonged.

Particularly, because all fabrication processes which would be preformed are known, indisputably, it is possible to decide the material and the formation of the passivation layer before the chamber is used, or after the chamber is cleaned. Moreover, because none of the fabrication processes would interact with the inner surface after the passivation layer is formed, the adjustment of the parameters of all fabrication processes could thoroughly depend on the effect on the wafer, and need not to consider the pollution from the inner surface which almost is inevitable for the conventional technology.

The claimed invention presents two preferred embodiments to explain how to practice the basic idea and the basic characteristic of the claimed invention.

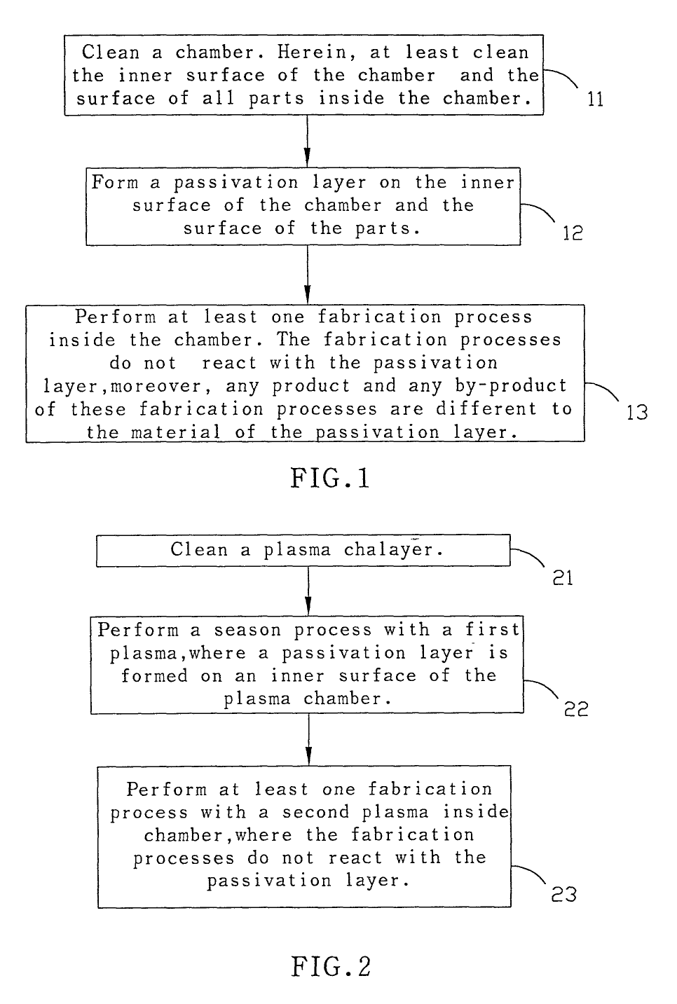

First preferred embodiment is a method of reducing the chamber particle level. As FIG. 1 shows, the embodiment at least includes following essential steps:

As clean block 11 shows, clean a chamber. Herein, at least clean the inner surface of the chamber, and also clean the surface of all parts inside the chamber.

As passivation layer 12 shows, form a passivation layer on the inner surface of the chamber, and also forms the passivation layer on the surface of the parts.

As performance block 13 shows, perform at least one fabrication process inside the chamber. The fabrication processes do not react with the passivation layer, moreover, any product and any by-product of these fabrication processes are different to the material of the passivation layer.

Significantly, according to the previous discussions, the interaction between these fabrication processes and the chamber should be negligible or even zero, the damage the fabrication processes induce on the passivation layer should be negligible or even zero, and the effect the fabrication processes induce on the passivation layer should be negligible or even zero, and the thickness of the passivation layer should almost or even fully be not affected by the fabrication processes.

Certainly, because one characteristic of this invention is forming the passivation layer to prevent the interaction between the inner surface of the chamber and the fabrication processes, whenever the fabrication processes form at least an additional layer on the inner surface while the passivation layer being not formed, the fabrication processes also possibly form the additional layers on the passivation layer. However, because the material of the passivation layer is adjustable, formation of the additional layers could be effectively prevented by choosing the proper material.

Besides, because one object of the invention is to decrease pollution, the choice of the material of the passivation layer should let the particles produced by the interaction between the fabrication processes and the passivation layer be as less as possible. Thus, the particles produced by the interaction between the fabrication processes and the additional layers would be as less as possible, and the peeling quantity of the passivation layer induced by the interaction between the fabrication processes and the passivation layer also would be as less as possible than the peeling quantity of the additional layers induced by the interaction between the fabrication processes and the additional layers. Further, because temperature variation, even electromagnetic field variation, usually is unavoidable during the fabrication processes, the thermal stability, even other property, of the passivation layer should be as higher as possible, or be more stable, than the thermal stability of the additional layers.

By the way, it should be emphasized that the invention only limits the passivation layer is formed on the inner surface, usually covers the inner surface, of the chamber, both the thickness and the shape of the passivation layer could be adjusted. Moreover, the invention does not limit whether the passivation layer physically adheres on the inner surface or chemically adheres on the inner surface, and also does not limit the passivation layer is formed by deposition, sputter, or other ways.

Another preferred embodiment is a method of enhancing the efficiency of a plasma chamber. As FIG. 2 shows, the embodiment at least includes following essential steps:

As clean clock 21 shows, clean a plasma chamber.

As season block 22 shows, perform a season process with a first plasma, where a passivation layer is formed on an inner surface of the plasma chamber.

As perform block 23 shows, perform at least one fabrication process with a second plasma inside chamber, where the interaction between the fabrication processes and the passivation layer is negligible, which means the fabrication processes usually do not react with the passivation layer.

Additional, the passivation layer is a polymer layer formed by the first plasma. Besides, the composition of the first plasma comprises the composition of the second plasma, but the composition of the second plasma does not comprises the composition of the first plasma. Moreover, the first plasma only is used by the season process and the second plasma only is used by the fabrication processes.

An applied example of the invention is using a plasma with fluorine to enhance the efficiency of a plasma chamber which use a plasma with chlorine to process aluminum. In the example, the composition of the first plasma at least comprises chlorine and fluorine, the composition of the second plasma comprising chlorine but without fluorine, and the passivation layer is a fluorine-base polymer layer. For example, the composition of the first plasma could comprise chlorine, fluorine, aluminum, and carbon. The composition of the first plasma also could comprise CxHyFz, where each of x, y, and z is positive integer, such as CHF3.

In the applied example, the reaction rate between the fluorine-base polymer layer and the second plasma, which only has chlorine but has not fluorine, is strongly less then the reaction rate between the fluorine-base polymer layer and the first plasma, which has fluorine, and also is less then reaction rate between the polymer layer formed by the second plasma and the second plasma. Hence, the fluorine-base polymer layer essentially is not react with the second plasma, and a direct result is that number of particles inside the chamber is decreased and the structure of the polymer layer is more stable.

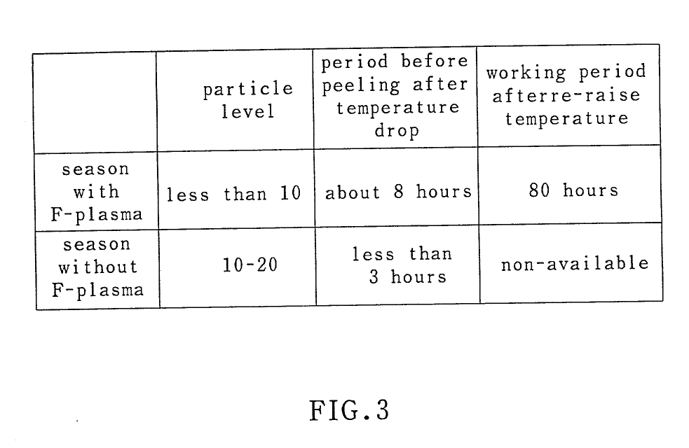

FIG. 3 briefly compares the experimental result which uses a plasma with fluorine (upper line) and the experimental result which use a plasma with chlorine but without fluorine (lower line). The experiment uses two LAM 9600 PTX Metal etchers as two chambers, after both the conventional clean process and the conventional maintenance process, two chambers are deposited a fluorine-base polymer layer and a chlorine-base polymer layer by the usage of the SEM wafer separately. Then, a plasma which has chlorine but has no fluorine is used to process the aluminum, and both the chamber particle level and the available working time after temperature variation are measured.

As shown in FIG. 3, the experimental results shows for the chamber uses the polymer layer without fluorine, the chamber particle level is about between 10 to 20, the polymer layer is peeled while the temperature inside the chamber is dropped from 75° C. to the room temperature and hold 3 hours. In comparison, for the chamber uses the polymer layer with fluorine, the chamber particle level is about less than 10, the polymer layer is not peeled while the temperature inside the chamber is dropped from 75° C. to the room temperature and hold about 8 hours.

Further, the experimental results shows for the chamber uses the polymer layer with fluorine, even the temperature inside the chamber is raised from the room temperature to the 75° C. after it is hold at the room temperature for about 8 hours, the chamber still could work about 80 hours while the chamber particle level is less than about 10.

From the foregoing it will be appreciated that, although specific embodiments of the invention have been described herein for the purpose of illustration, various modifications may be made without deviating from the spirit and scope of the invention. Accordingly, the invention is not limited except as by the appended claims.

What is claimed is:

1. A method of reducing the chamber particle level, comprising:
cleaning a chamber;
forming a passivation layer on an inner surface of said chamber; and
performing at least one fabrication process inside said chamber, wherein said fabrication processes do not react with said chamber.

2. The reducing method of claim 1, wherein said fabrication processes does not induce any damage on said passivation layer.

3. The reducing method of claim 1, wherein said fabrication processes does not affect said passivation layer.

4. The reducing method of claim 1, said fabrication processes form at least an additional layer on said inner surface while said passivation layer being not formed.

5. The reducing method of claim 4, said fabrication processes form said additional layers on said passivation layer.

6. The reducing method of claim 4, wherein the particles produced by the interaction between said fabrication processes and said passivation layer is less than the particles produced by the interaction between said fabrication processes and said additional layers.

7. The reducing method of claim 4, wherein the peeling quantity of said passivation layer induced by the interaction between said fabrication processes and said passivation layer is less than the peeling quantity of said additional layers induced by the interaction between said fabrication processes and said additional layers.

8. The reducing method of claim 4, where the thermal stability of said passivation layer is higher than the thermal stability of said additional layers.

9. The reducing method of claim 1, wherein the material of said passivation layer is different to the material of each product of said fabrication processes.

10. The reducing method of claim 1, wherein the material of said passivation layer is different to the material of each by-product of said fabrication processes.

11. The reducing method of claim 1, at least said inner surface being cleaned while said chamber being cleaned.

12. The reducing method of claim 1, while at least one part being located inside said chamber, said parts also being cleaned.

13. The reducing method of claim 12, said passivation layer also being formed on the surface of said parts.

14. A method of enhancing the efficiency of a plasma chamber, comprising:
cleaning a plasma chamber;
performing a season process with a first plasma, wherein a passivation layer is formed on an inner surface of said plasma chamber; and
performing at least one fabrication process with a second plasma inside said chamber, wherein said fabrication processes do not react with said chamber.

15. The enhancing method of claim 14, wherein said passivation layer is a polymer layer formed by said first plasma.

16. The enhancing method of claim 14, wherein the composition of said first plasma comprises the composition of said second plasma.

17. The enhancing method of claim 14, wherein the composition of said first plasma at least comprises chlorine and fluorine, while the composition of said second plasma comprising chlorine without fluorine.

18. The enhancing method of claim 17, the composition of said first plasma comprising chlorine, fluorine, aluminum, and carbon.

19. The enhancing method of claim 17, the composition of said first plasma comprising CxHyFz, wherein x, y, z are positive integer.

20. The enhancing method of claim 17, wherein said first plasma only is used by said season process and said second plasma only is used by said fabrication processes.
